(19) United States
(12) Patent Application Publication
(10) Pub. No.: US 2021/0321601 A1
(43) Pub. Date: Oct. 21, 2021

(54) DUAL FLUID NOZZLE BASED LIQUID SPRAY SYSTEM FOR UNMANNED AERIAL SYSTEMS

(71) Applicant: Application Insight, LLC, Lansing, MI (US)

(72) Inventors: Mark A. Ledebuhr, Lansing, MI (US); Wesley C. Hoffmann, Indianapolis, IN (US); Nicholas C. Tipper, Saint Johns, MI (US)

(21) Appl. No.: 17/236,067

(22) Filed: Apr. 21, 2021

Related U.S. Application Data
(60) Provisional application No. 63/012,993, filed on Apr. 21, 2020.

(51) Int. Cl. A01M 7/00; B64C 39/02

(52) U.S. Cl. CPC A01M 7/0014; B64C 39/024; B64D 1/18; A01M 7/0085; A01M 7/0089

(57) ABSTRACT

A twin-fluid atomized aerial spray system and method of aerial spraying includes flying an atomized spray delivery system with an unmanned aerial system. The atomized spray delivery system includes a first fluid delivery path, a second fluid delivery path and a spray nozzle. The first fluid delivery path has a liquid tank and the second fluid delivery path has a compressed gas tank, wherein the first and second fluid delivery paths deliver respective fluids to the spray nozzle. Liquid from the liquid tank is atomized with compressed gas from the compressed gas tank at the spray nozzle and delivers the atomized spray from the spray nozzle.

### CROSS REFERENCE TO RELATED APPLICATION

The present application claims priority of U.S. provisional application Ser. No. 63/012,993 filed Apr. 21, 2020, which is hereby incorporated herein by reference in its entirety.

### BACKGROUND AND FIELD OF THE INVENTION

The present invention is directed to an airborne spray system and, in particular, to such a spray system that is adapted for use with an unmanned aerial system (UAS) defined as remotely piloted, semi-autonomous or fully autonomous unmanned aircraft sometimes referred to as Drones. UAS may also refer to remote piloted aerial application systems (RPAAS), unmanned aerial vehicles (UAV) and the like. Craft within this field include “fixed wing”, “multi rotor”, “helicopter”, “multi-copter”, “lighter than air” and any hybrid thereof. UAS may refer to both sub 25 Kg as per FAA regulation 14 CFR Part 107, and also greater than 25 Kg UAS that do not comply with FAA regulation 14 CFR Part 107. While the invention is illustrated for use for adult mosquito control (audulticiding), it has other applications such as delivery of crop protection, chemicals for agriculture, forestry and release of various public health protection materials including mosquito larvicides, fungicides, bactericides or other fumigants.

Airborne spray systems for audulticiding are characterized by very fine droplets and very low applied rates, typically several ounces per acre. Airborne spray systems have typically utilized piloted fixed wing aircraft or helicopters. These systems lack the ability to precisely target small areas of interest, or apply at all in areas that are populated by humans where such application by a large aircraft at low altitude would be disruptive, or in areas that have vertical structure that would be dangerous to the aerial applicators. Thus, in addition to the obvious labor intensive and capital intensive nature of such prior systems, the spray pattern cannot be precisely controlled. The spray can be applied outside of the intended spray area such that the chemical is wasted and hazards can be created by spraying human populations and the like.

### SUMMARY OF THE INVENTION

The present invention provides a twin-fluid atomized liquid spray delivery system and method that is adapted to be carried by an unmanned aerial system. Embodiments of the invention are light enough to be carried by a UAS under 25 kg total weight. Because such a UAS can be programmed for on-board autonomous navigation and guidance with little or no input from ground control, it is extremely labor efficient. Additionally as such a UAS is small in scale and agile it is capable of precision handling and low level flight thus capable of restricting spray to an intended spray area. Embodiments of the invention provide even finer control over the droplet spectra, giving improved performance to the adulticide sprays by increasing the number of droplets of spray per mass, and decreasing their size allowing them to stay suspended in the air longer, making them more likely to collide with the target insect

According to an aspect of the present invention, an aerial spray system and method of aerial spraying includes flying an atomized spray delivery system with an unmanned aerial system. The atomized spray delivery system includes a first fluid delivery path, a second fluid delivery path and a spray nozzle. The first fluid delivery path has a liquid tank and the second fluid delivery path has a compressed gas tank, wherein the first and second fluid delivery paths deliver respective fluids to the spray nozzle. Liquid from the liquid tank is atomized with compressed gas from the compressed gas tank at the spray nozzle and deliver the atomized spray from the spray nozzle. The first fluid delivery path is for the liquid material to be applied and the second fluid delivery path is for the compressed gas used to create the atomization,

The technique may be used for mosquito adulticiding, wherein the compressed gas includes carbon dioxide wherein the residual compressed gas propellant dispersing with the atomized spray attracts adult mosquitoes. The first fluid delivery path may have a liquid flow regulator that regulates flow of liquid in the first fluid delivery path with the liquid flow regulator. The liquid flow regulator may include a pump, a flowmeter and a controller with the pump with controlled with the controller in response to the flowmeter to control flow of liquid in the first fluid delivery path. The pump may be a gear pump such as a micro-gear pump. The flowmeter may be a mass-flowmeter which is well-suited for measuring very small flows. The first fluid delivery path may have a multi-way valve and an air vent with the multi-way valve controlled with the controller to connect the liquid tank to flow to the nozzle in a first position and to connect the air vent to flow to the nozzle in a second position wherein the controller switches the multi-way valve from the first position to the second position to terminate spray. The pump may be driven by a reversible motor such that the motor is reversed by the controller to deliver liquid back to the liquid tank. The unmanned aerial system may include at least one rotor blade that produces an air downwash and the spray nozzle delivers the spray of atomized liquid outside of the air downwash. The liquid tank may have a flexible liquid bladder and a shell around said bladder.

The spray system can be fitted onto any UAS capable of lifting a payload of about 10 to 15 kilograms. Such payload is compatible with a UAS conforming to 14 CFR Part 107 limits of 25 Kg. total aircraft weight. Because such UAS can be flown without a pilot, the spray system is extremely labor conserving. The spray system according to embodiments of the invention is capable of generating an extremely fine droplet spectra at a necessary volume for the duration of the flight. Also, the spray may be precisely controlled to a degree that takes advantage of the precision of the UAS. Spray flow rate may be precisely controlled to match the speed of the UAS in order to maintain a uniform application rate. The mechanical simplicity of the disclosed embodiments provide failsafe structures in the event of malfunction or accident.

These and other objects, advantages, purposes and features of this invention will become apparent upon review of the following specification in conjunction with the drawings.

### BRIEF DESCRIPTION OF THE DRAWINGS

FIG. 1 is a perspective view of a multi-copter type unmanned aerial system (UAS) carrying an atomized spray delivery system according to an embodiment of the invention taken from the front right side thereof;

FIG. 2 is a perspective view of the system illustrated in FIG. 1 taken from the left side thereof;

FIG. 3 is the same view as FIG. 2 of atomized spray delivery system;

FIG. 4 is a fluid schematic diagram according to an embodiment of the invention;

FIG. 5 is a fluid schematic diagram according to an alternative embodiment of the invention;

FIG. 6 is a sectional view of an alternative embodiment of a liquid tank; and

FIG. 7 is the same view as FIG. 6 of another alternative embodiment of a liquid tank.

### DESCRIPTION OF THE PREFERRED EMBODIMENTS

The present invention will now be described with reference to the accompanying figures, wherein the numbered elements in the following written description correspond to like-numbered elements in the figures. An aerial spray system 10 includes an unmanned aerial system (UAS) 12 and an atomized spray delivery system 14 coupled to the unmanned aerial system. While illustrated as an octo-copter with 8 rotor blades, other forms of UASs can be used. While UAS 12 is available from various commercial sources, it meets the requirements of 14 CFR Part 107 limits of 25 Kg. total aircraft weight, which limits the weight that it can lift to about 10-25 kg or about 25 pounds. Thus system 14 must fit within that payload requirement. It should be understood that embodiments of the invention may find application with larger UASs that exceeds the 25 Kg 14 CFR Part 107 limitation. In addition to a heavier-than-air craft, UAS 12 could be a blimp or other lighter-than-air vehicles.

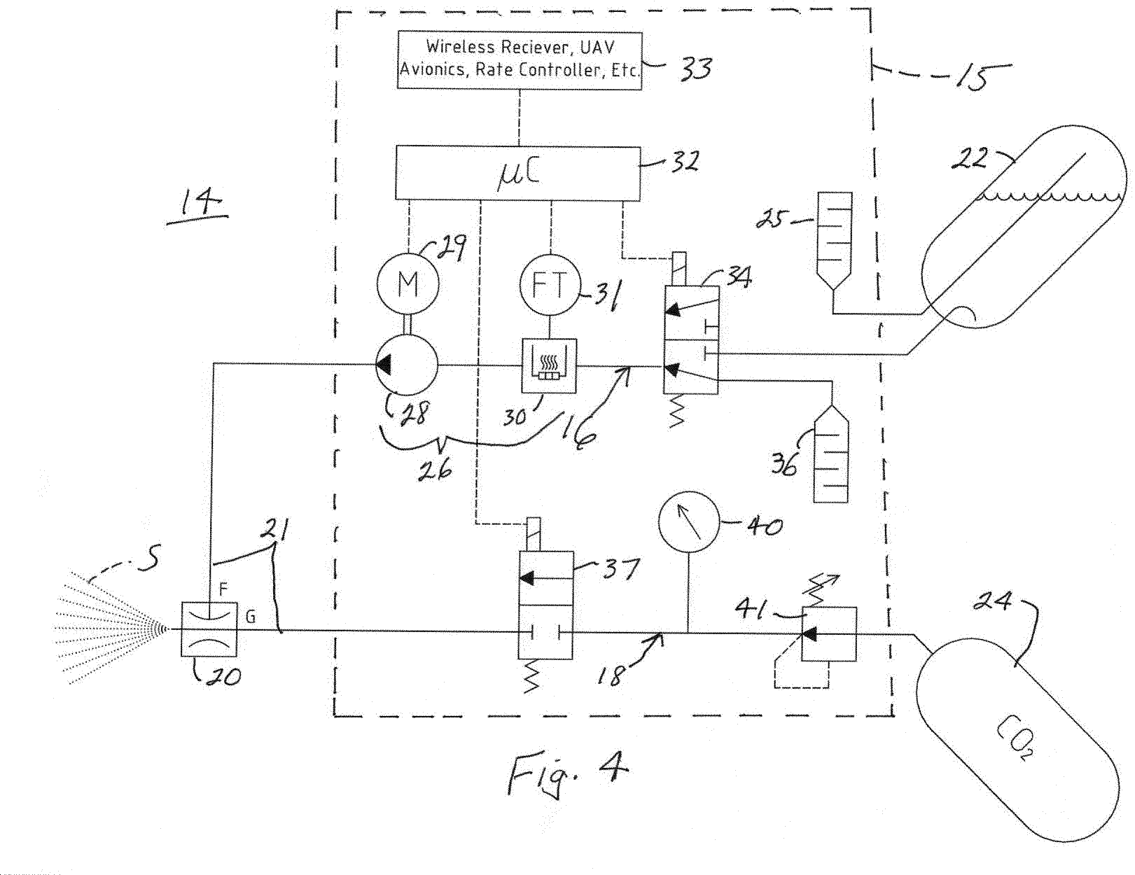

Atomized spray delivery system 14 includes a first fluid delivery path 16, a second fluid delivery path 18 and a spray nozzle 20. Spray nozzle 20 is adapted to deliver a spray of an atomized liquid. First fluid delivery path 16 delivers a fluid in the form of a liquid and second fluid delivery path 18 delivers a fluid in the form of a compressed gas. The compressed gas in second fluid delivery path 18 atomizes the liquid in first fluid delivery path into droplets and propels the droplets outward of the nozzle as a spray of droplets as illustrated at S in FIG. 4. The ratio of the gas flow in second fluid delivery path 18 to the mass flow of liquid in first fluid delivery path 16 determined droplet sized in the spray, which is also dependent on the nature of the liquid. In the illustrated embodiment, about 6 to 7 ounces of liquid per minute can be atomized to a desired droplet size spectra that is expected to allow an application to achieve a target rate of at about 4 ounces per acre. Lower rates per acre can be achieved and higher rated could be achieved with slower UAS travel speeds.

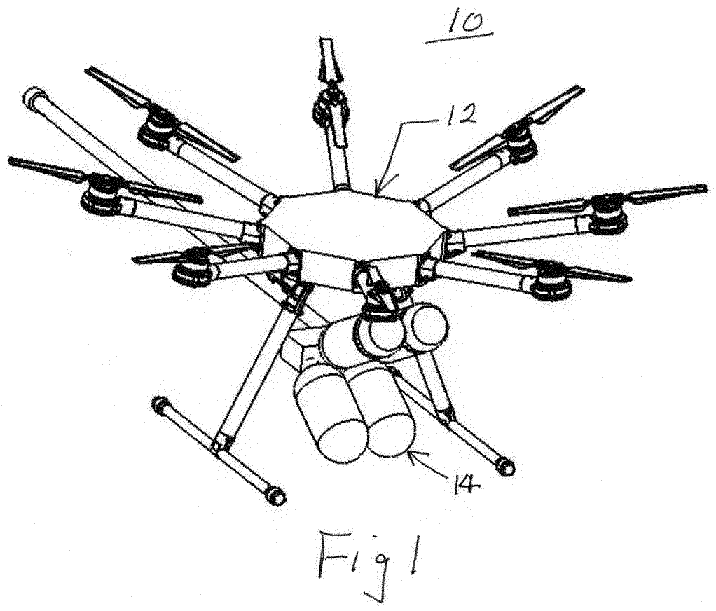

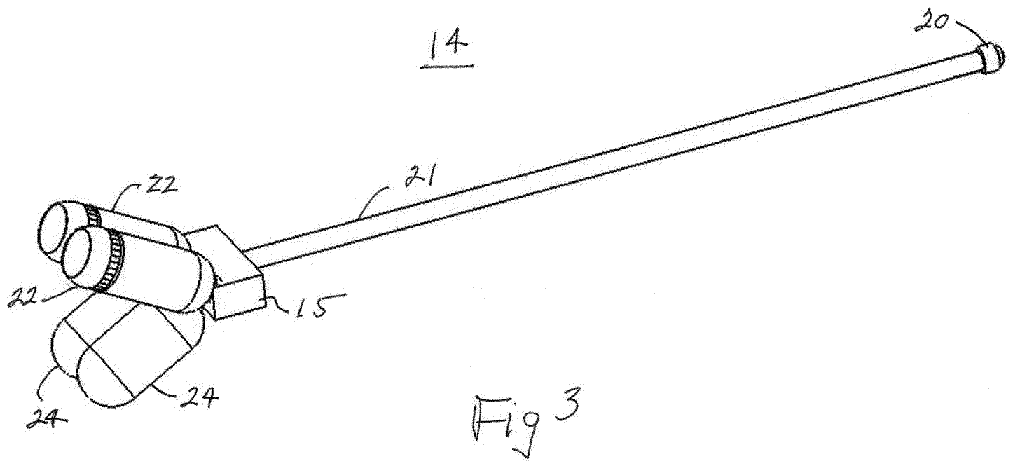

First fluid delivery path 16 includes a liquid tank 22 and a liquid flow regulator 26 that is adapted to regulate flow of liquid from the liquid tank. Although illustrated as a single tank in FIG. 4 liquid tank 22 can be made up of several liquid tanks connected in parallel flow as in the two tanks 22 shown in FIGS. 1 through 3. An air vent 25 prevents a vacuum forming in liquid tank 22. Liquid flow regulator 26 includes a pump 28 propelled by an electrical motor 29 whose speed is controlled by a controller 32, such as a microprocessor, and a liquid flowmeter 30 which is monitored by a flow transmitter 31 whose output is provided to controller 32. Controller 32 monitors meter 30 and controls pump 28 in a feedback loop so that increases in flow rate detected by flowmeter 30 can be offset by change in the speed of pump 28. Controller 32 can also set the absolute flow rate of liquid from tank 22. Flowmeter 30 in the illustrated embodiment is a mass flowmeter which is well-suited for very small flows using with atomized spray delivery system 14. A mass flowmeter operates similar to a hot-wire anemometer and is illustrated as a resistive heater. Other types of flowmeters could be used as long as they could sense a very low flow rate. Software code for controller 32 of atomized spray delivery system 14 can be separate or combined with communications and avionics software code of the avionics controller 33.

Second fluid delivery path 18 includes a compressed gas tank 24 and a pressure regulator 41 which manually sets the pressure exiting tank 24 along with a pressure gauge 40 that displays the pressure set by regulator 41. Gauge 40 and regulator 41 could be replaced by an automatically controlled regulator that is controlled by controller 32. Gas tank 24 could be a single tank as shown in FIG. 4 or multiple parallel connected tanks as illustrated in FIGS. 1 through 3. First and second fluid delivery paths 16, 18 terminate at spray nozzle 20 such that compressed gas from compressed gas tank 24 atomizes liquid from liquid tank 22 at the spray nozzle and propels the atomized spray from the spray nozzle.

First fluid delivery path 16 includes a multi-way valve 34 that is controlled by controller 32 and an air vent 36. Multi-way valve 34 is alternatively connecting liquid tank 22 to flow to nozzle 20 in a first position and air vent 36 to flow to the nozzle in a second position. Thus controller 32 is adapted to switch multi-way valve 34 from the first position to the second position to terminate spray. The second position of valve 34 cuts off liquid tank 22 from nozzle 20 and connects air vent 36 to the nozzle which clears out remaining liquid from the first flow delivery path. Alternatively or additionally, pump 28 may be driven by a reversible motor 29 such that the controller is adapted to reverse motor 28 to deliver liquid back into liquid tank 22 to terminate spray. Pump 28 is a gear pump in the illustrated embodiment which provides accurate control of fluid flow.

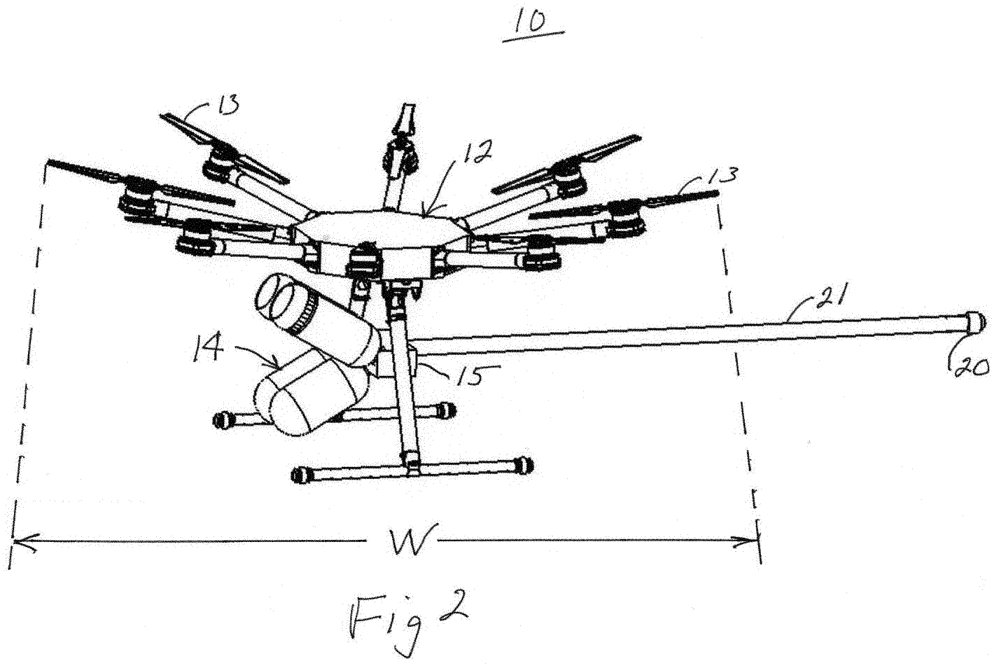

As best illustrated in FIG. 2, unmanned aerial system 12 includes one or more rotor blades 13 that produce an air downwash W. Spray nozzle 20 is mounted with a wand or boom 21 which positions the nozzle to deliver the spray of atomized liquid outside of air downwash W. This essentially dispenses the spray horizontally at the general flight altitude and prevents the air downwash from forcing the spray downward to a lower altitude than the spray system. Wand 21 could be adjustably mounted to allow selection between one orientation in which the spray is produced outside of wash W and another orientation in which the spray is produced within wash W for application vertically below the UAS.

First and second fluid delivery paths can be positioned along with the electronic controls previously described in a fluid manifold and electronic control module 15. Liquid tank(s) 22 and compressed gas tank(s) 24 can be mounted to module 15 either removeably or fixedly. If removeably mounted, such as with dry break connectors, extra tanks can be kept in a ready condition to replenish the system between flights. If fixedly connected, the tanks can be refilled between flights from bulk storage.

The illustrated embodiments have many applications but are especially useful for mosquito adulticide. This is accomplished by producing a spray W of very small droplet size notwithstanding oil based insecticides which are often used for adult mosquitoes. Also, while various gases, such as compressed air, can be used in compressed gas tank(s) 24, in the illustrated embodiment the compressed gas is illustrated as carbon dioxide. Since mosquitoes are attracted to carbon dioxide, residual compressed gas propellant dispersed with the atomized spray attracts adult mosquitoes to increase the effectiveness of the droplets produced.

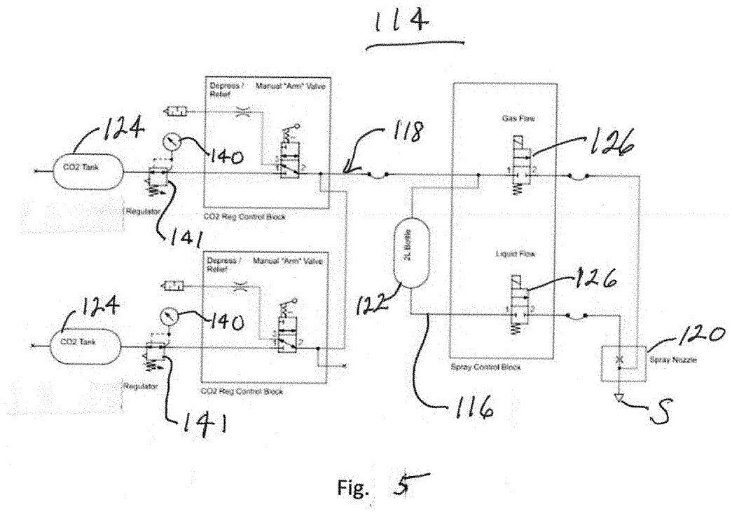

An alternative embodiment of an atomized spray delivery system 114 useful with an unmanned aerial system (not shown in FIG. 5) is shown with a second fluid delivery path 118 having a pair of compressed gas tanks 124 whose outputs are regulated by pressure regulator 141s and gauges 140. The compressed gas in second fluid delivery path 118 is directed to liquid tank 122 to pressurize the tank. This disburses liquid from tank 122 along first fluid deliver path 120. First and second First and second fluid delivery paths 116, 118 terminate at spray nozzle 120 such that compressed gas from compressed gas tanks 124 atomizes liquid from liquid tank 122 at the spray nozzle and propels the atomized spray from the spray nozzle. Flow regulators 126 are present in both first and second fluid delivery paths 116, 118. The flow regulators 126 will control the mixture of gas and liquid that is delivered to atomizing nozzle 120 to achieve the desired flowrate and droplet size. Flow regulators 126 are electronically signaled locking solenoids that conserve electrical power as only requiring power to change the positions of the valves.

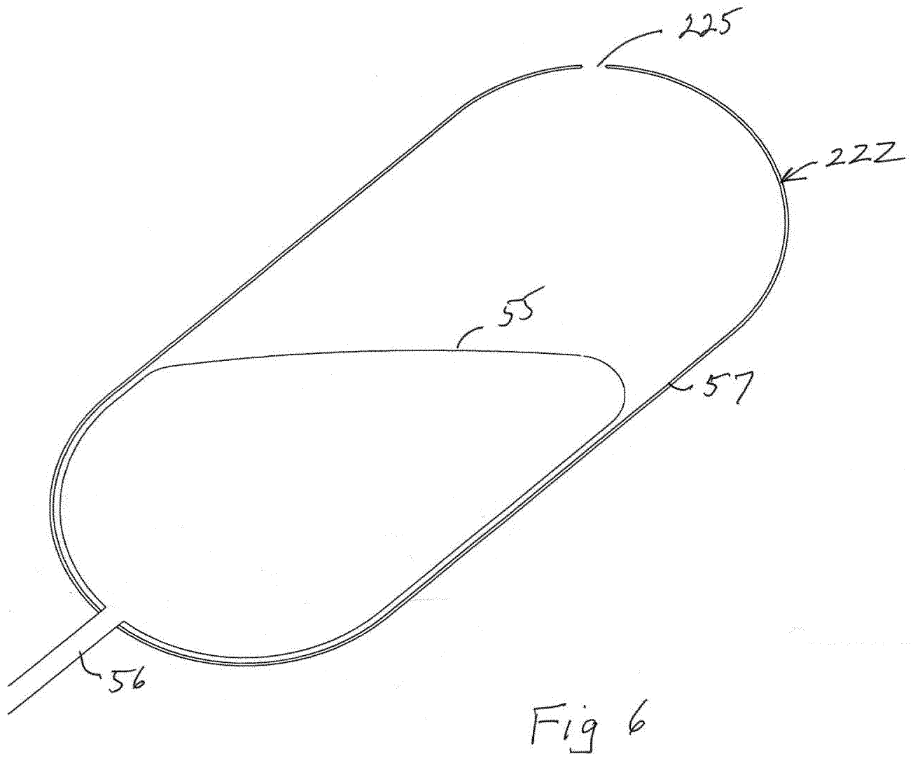

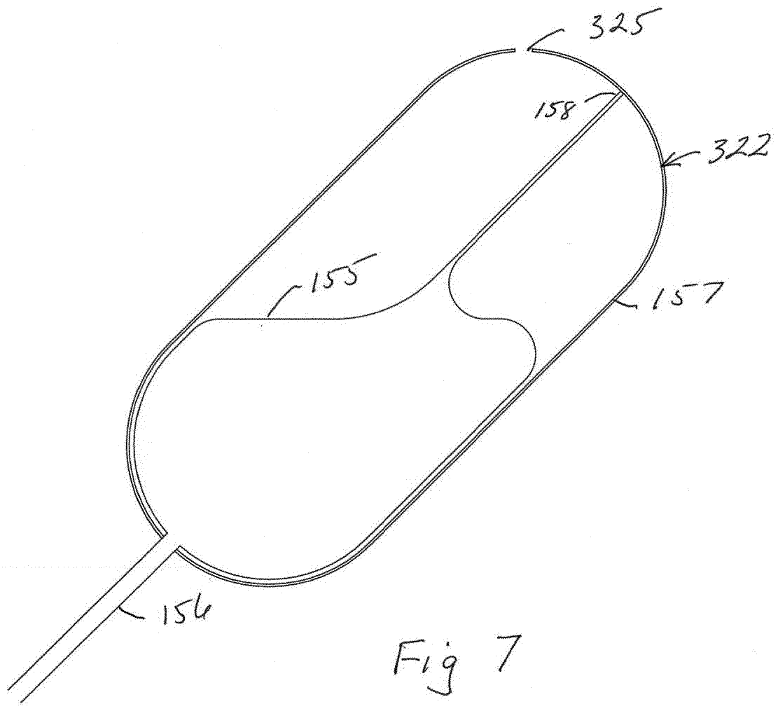

An alternative embodiment of a liquid tank 222 is illustrated in FIG. 6. Tank 222 includes a bladder 55 that is essentially a flexible bag that holds the liquid and collapses as the liquid is withdrawn from its opening 56. Liquid tank 222 also includes a rigid shell 57 that protects the bladder. A vent opening 225 in shell 57 allows bladder 55 to expand and collapse without any impediment from pressure buildup within shell 57. An advantage of liquid tank 222 is that it keeps the first fluid delivery path 16 closed and allows the liquid tank to be vented without leaking the liquid, which may be a very toxic insecticide. Another alternative embodiment liquid tank 322 shown in FIG. 7 is the same as liquid tank 222 except that the bladder 155 is affixed to shell 157 at 158. This helps stabilize bladder 155.

Other changes are possible. The UAS may be tethered to the ground with a two-channel hose and the fluids delivered to the UAS via the tether. Changes and modifications in the specifically described embodiments can be carried out without departing from the principles of the present invention which is intended to be limited only by the scope of the appended claims, as interpreted according to the principles of patent law including the doctrine of equivalents.

The embodiments of the invention in which an exclusive property or privilege is claimed are defined as follows:

1. An aerial spray system, comprising:
an unmanned aerial system;
an atomized spray delivery system coupled to said aerial system, said atomized spray delivery system comprising a first fluid delivery path, a second fluid delivery path and a spray nozzle that is adapted to deliver a spray of an atomized liquid; and
said first fluid delivery path comprising a liquid tank and said second fluid delivery path comprising a compressed gas tank, wherein said first and second fluid delivery paths terminate at said spray nozzle wherein compressed gas from said compressed gas tank atomizes liquid from said liquid tank at said spray nozzle and delivers the atomized spray from said spray nozzle.

2. The aerial spray system as claimed in claim 1 wherein said first fluid delivery path comprises a liquid flow regulator that is adapted to regulate flow of liquid in said first fluid delivery path.

3. The aerial spray system as claimed in claim 2 wherein said liquid flow regulator comprises a pump, a flowmeter and a controller, wherein said controller is adapted to control said pump in response to said flowmeter and thereby control flow of liquid in said first fluid delivery path.

4. The aerial spray system as claimed in claim 3 wherein said pump comprises a gear pump.

5. The aerial spray system as claimed in claim 3 wherein said flowmeter comprises a mass flowmeter.

6. The aerial spray system as claimed in claim 3 wherein said first fluid delivery path comprises a multi-way valve controlled by said controller and an air vent, said multi-way valve connecting said liquid tank to flow to said nozzle in a first position and said air vent to flow to said nozzle in a second position wherein said controller is adapted to switch said multi-way valve from said first position to said second position to terminate spray.

7. The aerial spray system as claimed in claim 3 wherein said pump is driven by a reversible motor and wherein said controller is adapted to reverse said motor to deliver liquid back into said liquid tank.

8. The aerial spray system as claimed in claim 1 wherein said liquid tank comprises a flexible liquid bladder and a shell around said bladder.

9. The aerial spray system as claimed in claim 1 wherein said unmanned aerial system comprises at least one generally horizontal rotor blade that produces an air downwash and wherein said spray nozzle is mounted with a wand that is configured to deliver said spray of atomized liquid outside of said air downwash.

10. An atomized spray delivery system that is adapted to be carried by an unmanned aerial system, said atomized spray delivery system comprising:
a first fluid delivery path, a second fluid delivery path and a spray nozzle that is adapted to deliver a spray of an atomized liquid; and
said first fluid delivery path comprising a liquid tank and said second fluid delivery path comprising a compressed gas tank, wherein said first and second fluid delivery paths terminate at said spray nozzle wherein compressed gas from said compressed gas tank atomizes liquid from said liquid tank at said spray nozzle and delivers the atomized spray from said spray nozzle.

11. The atomized spray delivery system as claimed in claim 10 wherein said first fluid delivery path comprises a liquid flow regulator that is adapted to regulate flow of liquid in said first fluid delivery path.

12. The atomized spray delivery system as claimed in claim 11 wherein said liquid flow regulator comprises a pump, a flowmeter and a controller, wherein said controller is adapted to control said pump in response to said flowmeter and thereby control flow of liquid in said first fluid delivery path.

13. The atomized spray delivery system as claimed in claim 12 wherein said pump comprises a gear pump.

14. The atomized spray delivery system as claimed in claim 12 wherein said flowmeter comprises a mass flowmeter.

15. The atomized spray delivery system as claimed in claim 12 wherein said first fluid delivery path comprises a multi-way valve controlled by said controller and an air vent, said multi-way valve connecting said liquid tank to flow to said nozzle in a first position and said air vent to flow to said nozzle in a second position wherein said controller is adapted to switch said multi-way valve from said first position to said second position to terminate spray.

16. The atomized spray delivery system as claimed in claim 12 wherein said pump is driven by a reversible motor and wherein said controller is adapted to reverse said motor to deliver liquid back into said liquid tank.

17. The aerial spray system as claimed in claim 10 wherein said liquid tank comprises a flexible liquid bladder and a shell around said bladder.

18. The atomize spray delivery system as claimed in claim 10 that is adapted for used with an unmanned aerial system having at least one generally horizontal rotor blade that produces an air downwash and wherein said spray nozzle is mounted to deliver said spray of atomized liquid outside of said air downwash.

19. A method of aerial spraying, comprising:
flying an atomized spray delivery system with an unmanned aerial system, said atomized spray delivery system comprising a first fluid delivery path, a second fluid delivery path and a spray nozzle, said first fluid delivery path comprising a liquid tank and said second fluid delivery path comprising a compressed gas tank, wherein said first and second fluid delivery paths deliver respective fluids to said spray nozzle; and
atomizing liquid from said liquid tank with compressed gas from said compressed gas tank at said spray nozzle and delivering the atomized spray from said spray nozzle.

20. The method of aerial spraying as claimed in claim 19 used for mosquito adulticide and wherein said compressed gas comprises carbon dioxide wherein residual compressed gas propellant dispersed with the atomized spray attracts adult mosquitoes.

21. The method of aerial spraying as claimed in claim 19 wherein said first fluid delivery path comprises a liquid flow regulator and including regulating flow of liquid in said first fluid delivery path with said liquid flow regulator.

22. The method of aerial spraying as claimed in claim 21 wherein said liquid flow regulator comprises a pump, a flowmeter and a controller, including controlling said pump with said controller in response to said flowmeter to control flow of liquid in said first fluid delivery path.

23. The method of aerial spraying as claimed in claim 22 wherein said pump comprises a gear pump.

24. The method of aerial spraying as claimed in claim 22 wherein said flowmeter comprises a mass flowmeter.

25. The method of aerial spraying as claimed in claim 22 wherein said first fluid delivery path comprises a multi-way valve and an air vent, including controlling said multi-way valve with said controller to connect said liquid tank to flow to said nozzle in a first position and said air vent to flow to said nozzle in a second position wherein said controller switches said multi-way valve from said first position to said second position to terminate spray.

26. The method of aerial spraying as claimed in claim 22 wherein said pump is driven by a reversible motor and reversing said motor with said controller to deliver liquid back into said liquid tank.

27. The method of aerial spraying system as claimed in claim 19 wherein said liquid tank comprises a flexible liquid bladder and a shell around said bladder.

28. The method of aerial spraying as claimed in claim 19 wherein said unmanned aerial system comprises at least one generally horizontal rotor blade that produces an air downwash and wherein said spray nozzle delivers said spray of atomized liquid outside of said air downwash.
